(19) United States
(12) Patent Application Publication
(10) Pub. No.: US 2025/0237285 A1
(43) Pub. Date: Jul. 24, 2025

(54) ADJUSTABLE POSITION SENSITIVE BASE VALVE

(71) Applicant: Fox Factory, Inc., Duluth, GA (US)

(72) Inventors: Ivan Tong, Odenton, MD (US); Connor Randall, Salida, CO (US); Nicholas Blake Edwin, Elbert, CO (US)

(73) Assignee: Fox Factory, Inc., Duluth, GA (US)

(21) Appl. No.: 18/419,296

(22) Filed: Jan. 22, 2024

(51) Int. Cl. F16F 9/49; F16F 9/34; F16F 9/44; F16K 15/08

(52) U.S. Cl. CPC F16F 9/49; F16F 9/34; F16F 9/44; F16K 15/08; F16F 2222/12; F16F 2228/066; F16F 2230/186

(57) ABSTRACT

A position sensitive apparatus is disclosed herein. The apparatus includes a position sensitive base valve comprising a plurality of ports and check plate to reduce fluid flow through at least one of the plurality of ports of the position sensitive base valve based on a location of a damping piston. The apparatus also includes a first spring coupling the check plate with the position sensitive base valve, the first spring biases the check plate away from the position sensitive base valve.

### FIELD OF THE INVENTION

Embodiments of the invention generally relate to methods and apparatus for use in a vehicle suspension.

### BACKGROUND OF THE INVENTION

Vehicle suspension systems typically include a spring component or components and a damping component or components that form a shock assembly to provide for a comfortable ride, enhance performance of a vehicle, and the like. Shock assemblies have a limited range of motion and are normally tuned to operate within that range. However, when an event (or plurality of events) is encountered, it is possible for the shock assembly to reach a maximum compression position. Once the shock assembly reaches the maximum compression and/or maximum extension position, any additional energies received to the shock assembly can cause the shock assembly to bottom out which refers to a deleterious impact between components within the shock assembly. As such, there is a constant need to develop solutions to reduce and/or resolve the occurrence of bottom out.

### BRIEF DESCRIPTION OF THE DRAWINGS

FIG. 1 is a perspective view of a shock assembly with a position sensitive bottom out zone structure, in accordance with an embodiment.

FIG. 2 is a cross section view of the position sensitive bottom out zone structure, in accordance with an embodiment.

FIG. 3A is a cross section view of the check plate and position sensitive base valve of the position sensitive bottom out zone structure, in accordance with an embodiment.

FIG. 3B is a bottom perspective view of the check plate and position sensitive base valve of the position sensitive bottom out zone structure, in accordance with an embodiment.

FIG. 4 is a cross section view of the check plate, position sensitive base valve, and an additional valve stack of the position sensitive bottom out zone structure, in accordance with an embodiment.

FIG. 5 is a cross section view of the shock assembly with a position sensitive bottom out zone structure with offset base valves, in accordance with an embodiment.

FIG. 6 is a cross section view of the shock assembly, with a position sensitive bottom out zone structure with offset base valves, at the start of the bottom out zone, in accordance with an embodiment.

FIG. 7 is a cross section view of the shock assembly with a position sensitive bottom out zone structure with offset base valves at a point of full entry into the bottom out zone, in accordance with an embodiment.

FIG. 8 is a perspective view of a bottom out zone adjustor shock body cap for the shock assembly with the position sensitive bottom out zone structure, in accordance with an embodiment.

FIG. 9 is a cross-section view of the bottom out zone adjustor shock body cap for the shock assembly with the position sensitive bottom out zone structure, in accordance with an embodiment.

FIG. 10 is a cross section view of a needle and bleed port and the position sensitive base valve of the position sensitive bottom out zone structure in a ride zone, in accordance with an embodiment.

FIG. 11 is a cross section view of a needle and bleed port and the position sensitive base valve of the position sensitive bottom out zone structure at the point of full entry into the bottom out zone, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

In the following discussion, working fluid of “fluid” refers to a non-compressible fluid that is used in one or more aspects of the shock assembly. Examples of a non-compressible fluid include liquids such as oils, water, and the like. Compressible fluid refers to a fluid that is used in one or more aspects of the internal floating piston (IFP) assembly. Examples of compressible fluid includes gases such as nitrogen, carbon dioxide, air, and the like.

The term “ride zone” refers to the standard range of operation for a shock assembly, in other words the normal range of compression and rebound motion of the shock during standard use (e.g., over flat ground, bumps, turns, etc.).

The term “bottom out zone” refers to the more extreme range of operation for a shock assembly, e.g., when the shock is compressed past the ride zone and risks bottoming out or having components such as the damping piston, shaft, and the like, coming into contact with other components such as the shock body, body cap, or the like.

As previously discussed, bottoming out a shock assembly is undesirable as it can damage the shock assembly, create a loud noise and/or unpleasant experience for the user, and the like. Embodiments described herein aid in bottom out prevention with position sensitive damping technology, provide pressure balancing the shock assembly, and/or reduce cost while maintaining functionality.

Embodiments described herein provide an adjustable position sensitive bottom out zone structure. It should be noted that embodiments described herein are compatible with both monotube and concentric cylinder shock assembly designs. Furthermore, as embodiments do not require a bottom out cup, utilizing the position sensitive bottom out zone structure will provide a reduced dead length for a shock assembly.

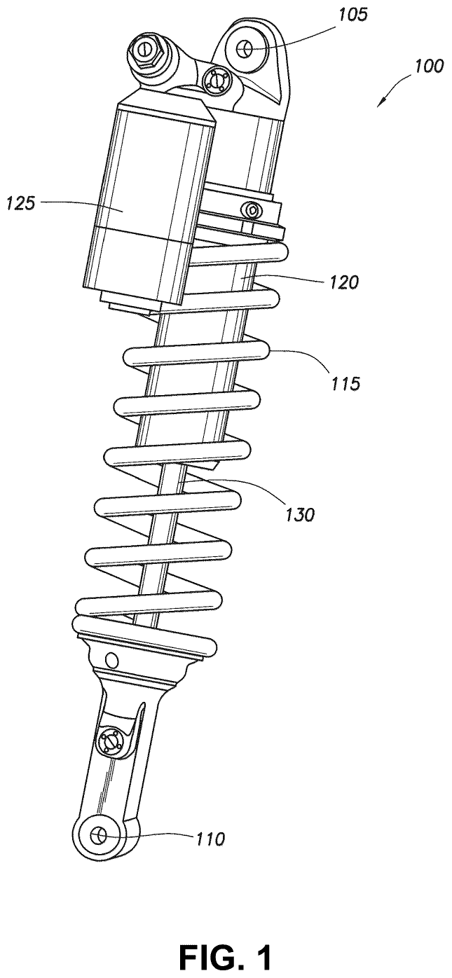

FIG. 1 includes a helical spring 115, a damper housing 120 with a piston and chamber (shown in further detail herein), an upper eyelet 105, a lower eyelet 110, and an external reservoir 125 having a floating piston and pressurized gas to compensate for a reduction in volume in the main damper chamber of the shock assembly as the shaft 130 moves into the damper housing 120 during a compression stroke. Fluid communication between the main chamber of the damper and the external reservoir 125 may be via a flow channel including an adjustable needle valve. Further detail and description of an external reservoir is described in U.S. Pat. No. 7,374,028 which is entirely incorporated herein by reference.

In one embodiment, the upper eyelet 105 and lower eyelet 110 are used for mounting one end of the shock assembly to a static portion of the vehicle and the other end of the shock assembly to a dynamic portion of the wheel(s) (or ski, track, hull, etc.) retaining assembly. Although eyelets are shown, it should be appreciated that the mounting systems may be bolts, welds, or the like, the use of eyelets is provided as one embodiment and for purposes of clarity.

Although the eyelets are labeled as upper eyelet 105 and lower eyelet 110, this is providing as one embodiment, and for purposes of defining relative motion of one or more of the components of shock assembly 100. Thus, it should be appreciated that in one embodiment, (such as an inverted scenario) the mounting of shock assembly 100 could be with the upper eyelet 105 being at a lower point (such as closer to the wheel retaining assembly) while the lower eyelet 110 would actually be at a higher point on the vehicle than upper eyelet 105 (e.g., such as at the frame of the vehicle). It should also be appreciated that the adjustable position sensitive base valve discussed herein could be used on one or more shock assemblies of different types, and in an assortment of vehicles such as, but not limited to a bicycle, motorcycle, ATV, jet ski, car, snow mobile, side-by-side, and the like.

Although a coil sprung shock assembly 100 is shown in FIG. 1, this is provided as one embodiment and for purposes of clarity. In one embodiment, the shock assembly 100 could be a different type such as, but not limited to, an air sprung fluid damper assembly, a stand-alone fluid damper assembly, and the like.

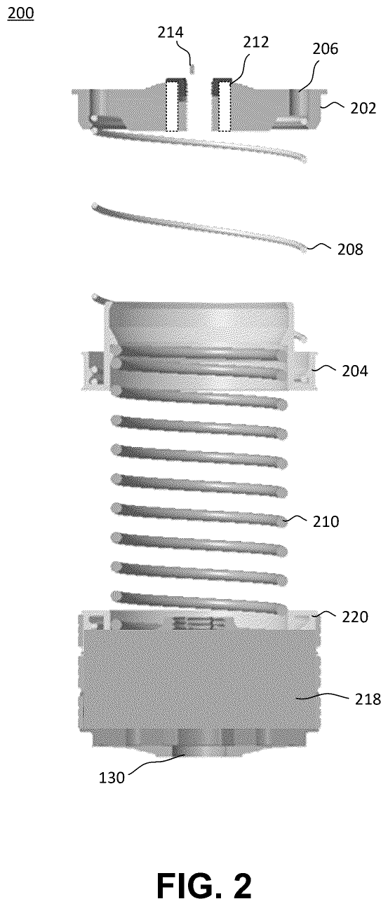

Referring now to FIG. 2, a cross section view of the position sensitive bottom out zone structure 200 is shown in accordance with an embodiment. In one embodiment, the position sensitive bottom out zone structure 200 is located within the damper housing 120 of FIG. 1 and discloses one or more additional components that are visible in the cross-section view. For example, FIG. 2 shows a damping piston 218 coupled with the shaft 130.

In operation, the damping piston 218 and shaft 130 are axially movable within a main chamber of damper housing 120 toward or away from upper eyelet 105. For example, during a compression stroke the damping piston 218 and shaft 130 move axially through the main chamber toward upper eyelet 105. In contrast, during a rebound stroke, the damping piston 218 and shaft 130 move axially through the main chamber away from upper eyelet 105.

In one embodiment, the damping piston 218 divides the main chamber into a compression side and a rebound side. The damping piston 218 is equipped with fluid paths therethrough to permit damping fluid within the main chamber to be metered therethrough during the compression and/or rebound movement. For example, in the compression stroke, at least a portion of fluid within main chamber utilizes the fluid paths through damping piston 218 to move from a compression side of main chamber to the rebound side of the main chamber. In contrast, during a rebound stroke, at least a portion of fluid within the main chamber utilizes the fluid paths through damping piston 218 to move from the rebound side to the compression side.

In one embodiment, shock assembly 100 includes one or more bypasses that allow fluid to flow around damping piston 218 between the compression side and the rebound side of the main chamber during at least a portion of the compression and/or rebound stroke. Additional information regarding the configuration and operation of a bypass is described in U.S. Pat. No. 8,857,580 which is entirely incorporated herein by reference.

In one embodiment, position sensitive bottom out zone structure 200 includes a position sensitive base valve 202, a first spring 208, a check plate 204, a second spring 210, and a spring retainer 220. In one embodiment, the position sensitive bottom out zone structure 200 is coupled with the damping piston 218 on the side opposite of the shaft 130.

Position sensitive base valve 202 includes one or more outer diameter (OD) ports 206 and one or more inner diameter (ID) ports 212. In one embodiment, there is only one OD port. In one embodiment, there are a plurality of OD ports 206 spread about the OD of the position sensitive base valve 202. In one embodiment, each of the OD ports 206 has a similar radial distance from the center of position sensitive base valve 202.

In one embodiment, there is only one ID port. In one embodiment, there are a plurality of ID ports 212 spread about an inner diameter of the position sensitive base valve 202. In one embodiment, each of the ID ports 206 has a similar radial distance from the center of position sensitive base valve 202.

In one embodiment, there is no first spring 208. Instead, a first end of second spring 210 is coupled with damping piston 218 and a second end of the second spring 210 is coupled with check plate 204 such that a motion of the damping piston 218 (e.g., a compression or rebound movement) will translate via second spring 210 to check plate 204 causing check plate 204 to have a similar motion (or movement) as damping piston 218.

In one embodiment, spring retainer 220 is coupled with damping piston 218. In one embodiment, spring retainer 220 is coupled with shaft 130. Spring retainer 220 retains second spring 210 which is coupled with check plate 204. In general, second spring 210 provides an initial offset between the check plate 204 and the damping piston 218 as well as an opening pressure (e.g., the spring force) therebetween.

Optional first spring 208 is coupled between check plate 204 and position sensitive base valve 202. For example, a first end of first spring 208 is coupled with the position sensitive base valve 202 while a second end of first spring 208 is coupled with check plate 204. In so doing, first spring 208 connectively couples check plate 204 with said position sensitive base valve 202.

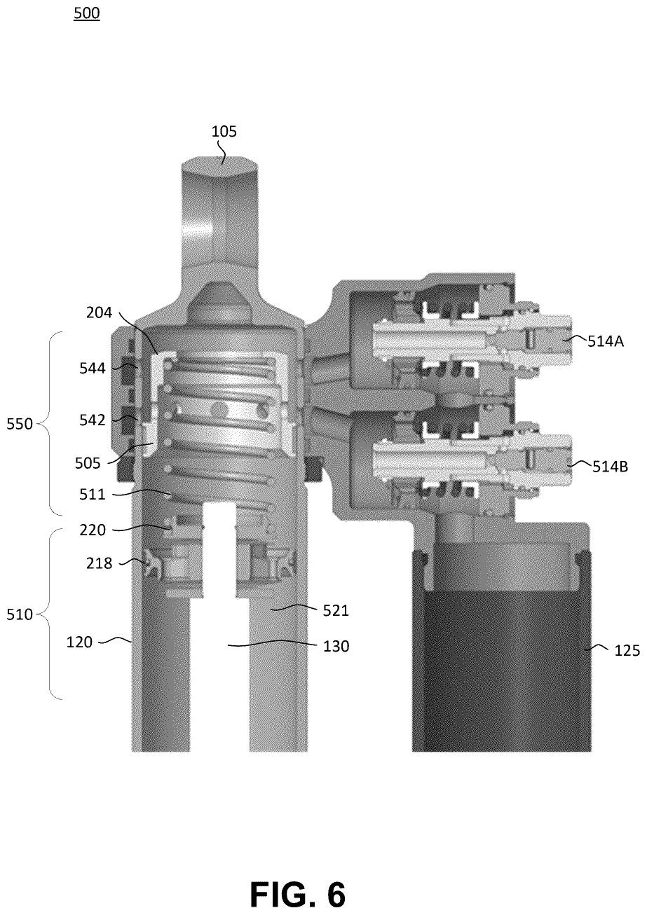

In general, first spring 208 provides an initial offset between check plate 204 and position sensitive base valve 202. In one embodiment, first spring 208 has a lighter spring constant than second spring 210. In one embodiment, when both first spring 208 and second spring 210 are used in the system, instead of check plate 204 moving in concert with the motion of damping piston 218, the check plate 204 will remain in a relatively fixed location while damping piston 218 is within a ride zone (e.g., ride zone 510 of FIG. 6), maintain position sensitive bottom out zone structure 200 in an open position.

In one embodiment, while position sensitive bottom out zone structure 200 is in an open position (e.g., the position sensitive base valve 202 is separated from check plate 204), working fluid can flow freely through the OD ports 206 of the position sensitive base valve 202. In other words, the fluid flows unrestrictedly through OD ports 206 and the position sensitive base valve 202 does not significantly modify any damping characteristics of the shock assembly.

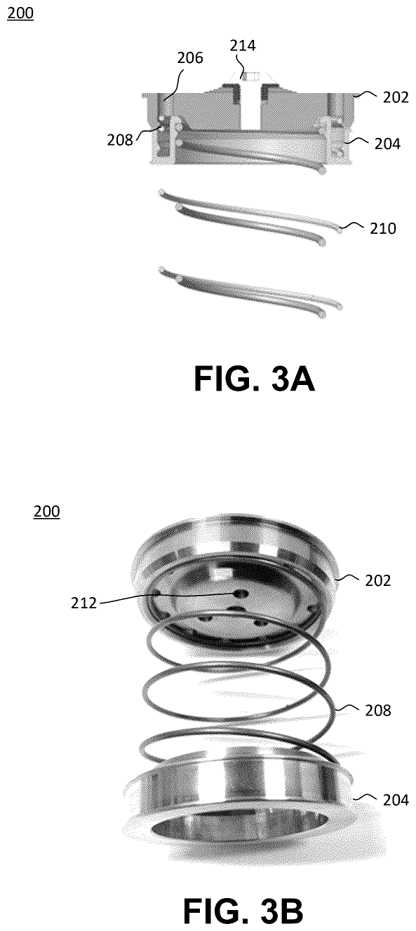

With reference now to FIG. 3A, a cross section view of the check plate 204 and position sensitive base valve 202 of the position sensitive bottom out zone structure 200 is shown in accordance with an embodiment. Also shown are OD ports 206, first spring 208, second spring 210, and valve 214.

Referring now to FIG. 3B, a bottom perspective view of the check plate 204 and position sensitive base valve 202 of the position sensitive bottom out zone structure 200 is shown in accordance with an embodiment. As described herein, check plate 204 includes one or more ID ports 212.

In one embodiment, the fluid flow rate (or fluid flow) through ID ports 212 is controlled by valve 214. In one embodiment, valve 214 is a pre-set blow-off type valve such as a spool valve, a shim valve, and the like.

With reference now to both FIG. 3A and FIG. 3B, in one embodiment, OD ports 206 are a different diameter than ID ports 212. In one embodiment, OD ports 206 are the same diameter as ID ports 212. In one embodiment, there are a number of OD ports 206 oriented about the perimeter of position sensitive base valve 202. In one embodiment, the ID ports 212 are clustered about the central region of position sensitive base valve 202.

At FIG. 3A, the position sensitive bottom out zone structure 200 is shown in a reduced (or restricted) flow orientation. That is, as check plate 204 approaches position sensitive base valve 202, check plate 204 will reduce and/or block the fluid flow through OD ports 206. Thereafter, any fluid flow through position sensitive base valve 202 will have to utilize ID ports 212 and thus exceed the cracking pressure of valve 214.

For example, as the shock assembly 100 approaches a bottom out zone 550 (as shown in FIG. 6) during a compression stroke, the movement of the shaft 130 will overcome the spring force of first spring 208 and cause the check plate 204 to move toward and finally close with the position sensitive base valve 202. This closure will reduce and/or block the fluid flow through OD ports 206 and cause the position sensitive bottom out zone structure 200 to increases fluid flow resistance.

Thus, after the check plate 204 moves toward and finally closes with the position sensitive base valve 202, there will be an increase in the compression damping characteristics of shock assembly 100. This increase in compression damping characteristics of shock assembly 100 will significantly reduce or remove the opportunity for a deleterious bottom out impact.

During a rebound stroke, OD ports 206 are able to handle the entirety of the fluid flow such that ID ports 212 are not required to accommodate fluid flow therethrough. As such, in one embodiment, the ID ports 212 do not need check shims to manage the rebound fluid flow.

For example, during the rebound stroke, the force on check plate 204, applied by the movement of shaft 130, will be reduced to less than the spring force of first spring 208. In so doing, first spring 208 will separate check plate 204 and position sensitive base valve 202 such that fluid flow through OD ports 206 is no longer reduced or restricted.

In one embodiment, position sensitive bottom out zone structure 200 assists in pressure balancing the shock assembly 100. In one embodiment, position sensitive bottom out zone structure 200 does not affect the nitrogen pressure on the backside of the external reservoir IFP. This pressure balancing reduces the cavitation levels within the shock assembly 100. In one embodiment, the position sensitive bottom out zone structure 200 lowers the nitrogen pressure requirements for the IFP.

In one embodiment, position sensitive bottom out zone structure 200 is compatible with legacy equipment, and can be installed with minimal adjustments.

In one embodiment, instead of the fluid flow through ID ports 212 being controlled by valve 214 the fluid flow through OD ports 206 are controlled by valve 214. In one embodiment, as check plate 204 approaches position sensitive base valve 202, instead of the check plate 204 reducing and/or blocking the fluid flow through OD ports 206, the check plate 204 will reduce and/or block the fluid flow through ID ports 212. Thereafter, any fluid flow through position sensitive base valve 202 will have to utilize OD ports 206 and thus exceed the cracking pressure of valve 214.

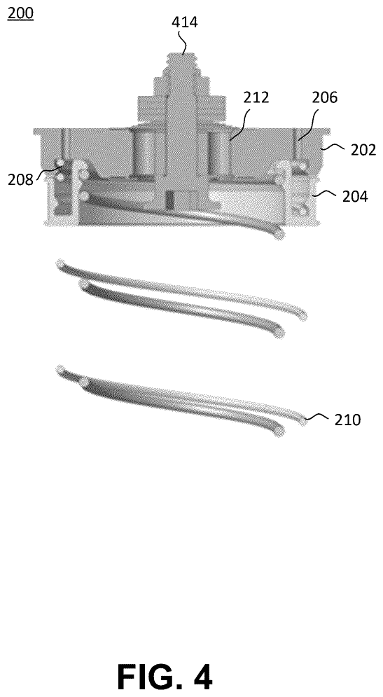

Referring now to FIG. 4, a cross section view of the check plate 204, position sensitive base valve 202, and valve 414 of the position sensitive bottom out zone structure 200 is shown in accordance with an embodiment. In the following discussion, the description of the components of FIG. 4 that are similar to those described in FIG. 3A are not repeated for purposes of clarity but are incorporated herein by reference in their entirety.

In FIG. 4, instead of utilizing a pre-set blow-off type of valve 214, position sensitive base valve 202 utilizes valve 414 to meter fluid flow through the ID ports 212. Valve 414 can be a spool valve, a shim valve, a pressure relief valve, an electronic valve, a solenoid, and the like.

In one embodiment, valve 414 is set to a fixed cracking pressure. In one embodiment, valve 414 has a tunable cracking pressure. In general, valve 414 can be a manually tunable valve, an active valve, a semi active valve, a user controlled valve, an electronic valve, and the like. In one embodiment, instead of (or in addition to) restricting the flow through the ID ports 212, valve 414 will vary a flow rate through an inlet or outlet passage within the valve 414, itself. In other words, valve 414, can be used to meter the working fluid flow (e.g., control the rate of working fluid flow) with/or without adjusting the flow rate through the ID ports 212.

In one embodiment, valve 414 is used in conjuncture with an internal bypass, which aids in pressure balancing the shock assembly 100. In one embodiment, valve 414 acts as a conventional valve until check plate 204 is engaged with position sensitive base valve 202 at which point the fluid that flows through valve 414 will be moved into an external reservoir 125 (or a piggyback chamber, remote reservoir, etc.).

Additional information regarding active and semi-active valves, including those used for compression and/or rebound stiffness adjustments, preload adjustments, bottom out control, preload adjustment, ride height adjustment, and the like see, as an example, U.S. Pat. Nos. 9,353,818 and 9,623,716 the content of which are incorporated by reference herein, in their entirety.

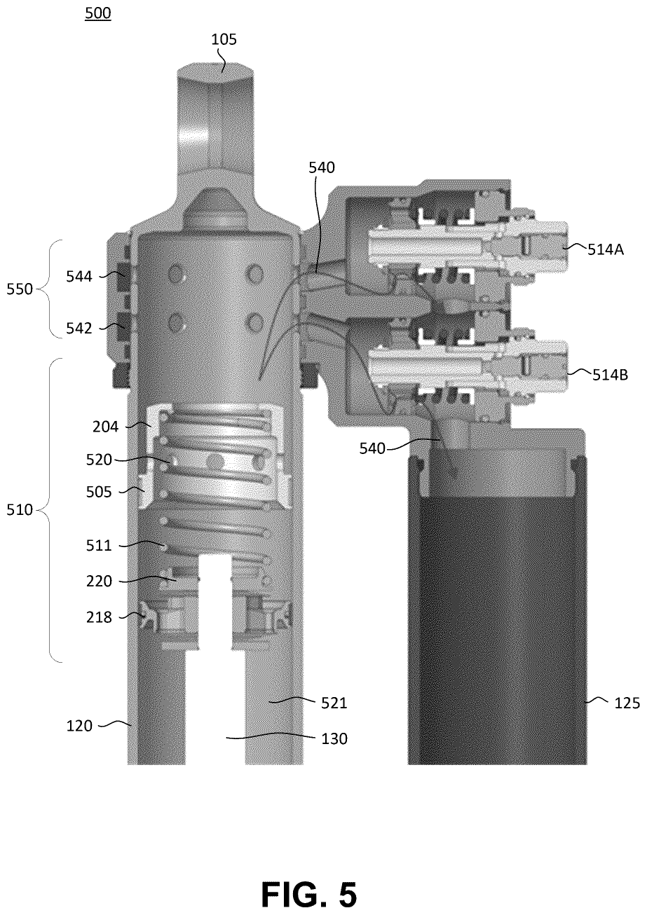

With reference now to FIG. 5, a cross section view of shock assembly 500 with a position sensitive bottom out zone structure 200 with offset base valves 514A and 514B is shown in accordance with an embodiment. In general, a number of the features of shock assembly 500 are similar to that of shock assembly 100 of FIG. 1 and to the position sensitive bottom out zone structure 200 of FIG. 2. As such, the description of the components of FIG. 5 that are similar to those described in FIGS. 1 and 2 are not repeated for purposes of clarity but are incorporated herein by reference in their entirety.

In one embodiment, position sensitive bottom out zone structure 200 includes a check plate 204, a spring 511 (similar to second spring 210), and optionally a spring retainer 220. In one embodiment, the position sensitive bottom out zone structure 200 is coupled with the damping piston 218 on the side opposite of the shaft 130.

A first end of spring 511 is coupled with damping piston 218 and a second end of the spring 511 is coupled with check plate 204 such that a motion of the damping piston 218 (e.g., a compression or rebound movement) will translate via spring 511 to check plate 204 causing check plate 204 to have a similar motion (or movement) as damping piston 218.

In general, spring 511 provides an initial offset between the check plate 204 and the damping piston 218 as well as an opening pressure (e.g., the spring force) therebetween. That is, spring 511 maintain position sensitive bottom out zone structure 200 in an open position while the shock assembly 500 (and more specifically damping piston 218) is operating within a ride zone 510.

In one embodiment, spring retainer 220 is coupled with damping piston 218. In one embodiment, spring retainer 220 is coupled with shaft 130. Spring retainer 220 retains spring 511 which is coupled with check plate 204.

Damper housing 120 of shock assembly 500 includes a main chamber 521. In operation, the damping piston 218 and shaft 130 are axially movable within main chamber 521 toward or away from upper eyelet 105. For example, during a compression stroke the damping piston 218 and shaft 130 move axially through the main chamber 521 toward upper eyelet 105. In contrast, during a rebound stroke, the damping piston 218 and shaft 130 move axially through the main chamber 521 away from upper eyelet 105.

In one embodiment, main chamber 521 includes upper ports 544 and lower ports 542. In a compression stroke within the ride zone 510, the working fluid will flow from the main chamber 521 through both the upper ports 544 and lower ports 542, through the associated base valves (e.g., base valves 514A and 514B) and into reservoir 125 as indicated by flow path 540.

During a rebound stroke the working fluid will return from the reservoir 125 into the main chamber 521 via both the upper ports 544 and lower ports 542 and their associated base valves (e.g., base valves 514A and 514B).

Check plate 204 includes at least one port 520 therethrough and an OD portion 505 configured to provide a fluid seal between the main chamber 521 and check plate 204.

Port 520 allows the check plate 204 to move freely through the fluid and allows the fluid to move freely past the check plate 204. While check plate 204 is in an open position (e.g., the system is operating within the ride zone 510), working fluid flow rates (and as such, the compression damping characteristics of the shock assembly 500) will be controllable via both the upper ports 544 and lower ports 542 and their associated base valves (e.g., base valves 514A and 514B).

In one embodiment, base valves 514A and 514B are identical. In one embodiment, base valves 514A and 514B are different valves. In one embodiment, one or both of base valve 514A and base valve 514B are tunable. In one embodiment, one or both of base valve 514A and base valve 514B are non-adjustable. In one embodiment, one or both of base valve 514A and base valve 514B are variable pressure valves that would increase the force with fluid pressure exerted on the valves. In one embodiment, base valves 416 are non-adjustable. In one embodiment, one or both of base valve 514A and base valve 514B are a spool valve, a shim valve, a pressure relief valve, an electronic valve, a solenoid, and the like, or a combination thereof. In one embodiment, an additional base valve is used in an inline fluid flow position.

In one embodiment, base valve 514B uses a softer compression setting (or tune) while base valve 514A has a firmer compression setting (or tune) such that when the shock assembly 500 is operating in the ride zone 510 and both lower ports 542 and upper ports 544 are open, the shock assembly 500 will have a softer compression tune and provided improved comfort.

Referring now to FIG. 6, a cross section view of the shock assembly 500, with a position sensitive bottom out zone structure 200 with offset base valves 514A and 514B, at the start of the bottom out zone 550, is shown in accordance with an embodiment. In general, a number of the features of FIG. 6 are similar to that of FIG. 5. As such, the description of the components of FIG. 6 that are similar to those described in FIG. 5 are not repeated for purposes of clarity but are incorporated herein by reference in their entirety.

As the check plate 204 starts to enter the bottom out zone 550 (as the shock assembly 500 moves through a compression stroke), OD portion 505 will begin to close off (or partially block) lower ports 542 and restrict or reduce the flow rate of the fluid that passes therethrough. As such, during the remainder of the compression stroke, most of the fluid will have to flow through the upper ports 544 to reach reservoir 125.

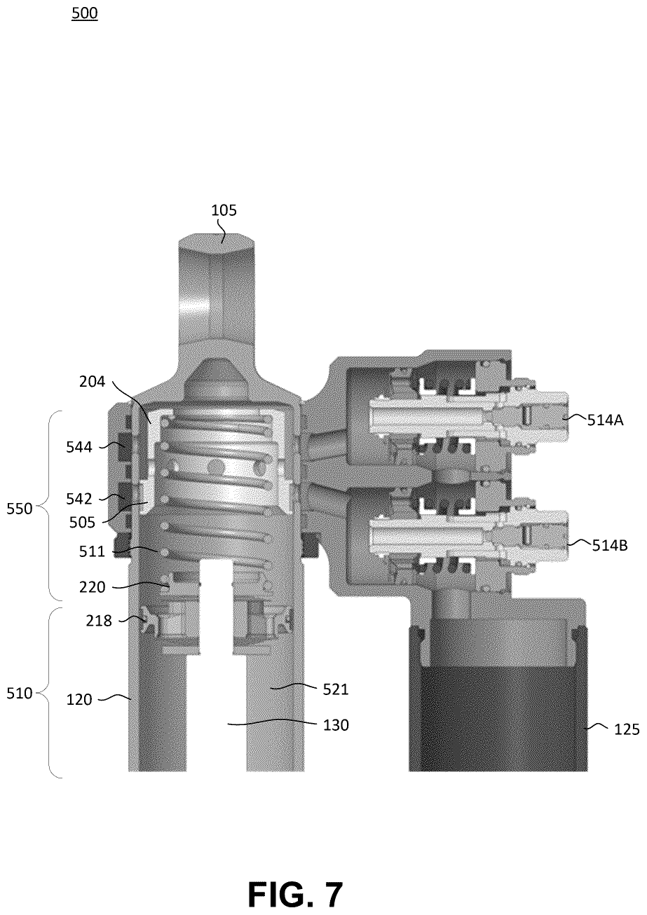

Referring now to FIG. 7, a cross section view of the shock assembly 500, with a position sensitive bottom out zone structure 200 with offset base valves 514A and 514B, in the bottom out zone 550 is shown in accordance with an embodiment. In general, a number of the features of FIG. 7 are similar to that of FIGS. 5 and 6. As such, the description of the components of FIG. 7 that are similar to those described in FIGS. 5 and 6 are not repeated for purposes of clarity but are incorporated herein by reference in their entirety.

In one embodiment, once the check plate 204 is fully within the bottom out zone 550, OD portion 505 will reduce and/or block the fluid flow through lower ports 542 and the only open fluid pathway into reservoir 125 will be through the upper ports 544.

As discussed herein, in one embodiment, base valve 514B uses a softer compression setting (or tune) while base valve 514A has a firmer compression setting (or tune). Thus, when the shock assembly 500 is operating in the bottom out zone 550, the lower ports 542 (and the softer compression setting base valve 514B) are closed to fluid flow while the upper ports 544 (and the firmer compression setting base valve 514A) will remain open thereby causing an increase in the compression damping characteristics of shock assembly 500. This increase in compression damping characteristics of shock assembly 500 will significantly reduce or remove the opportunity for a deleterious bottom out impact.

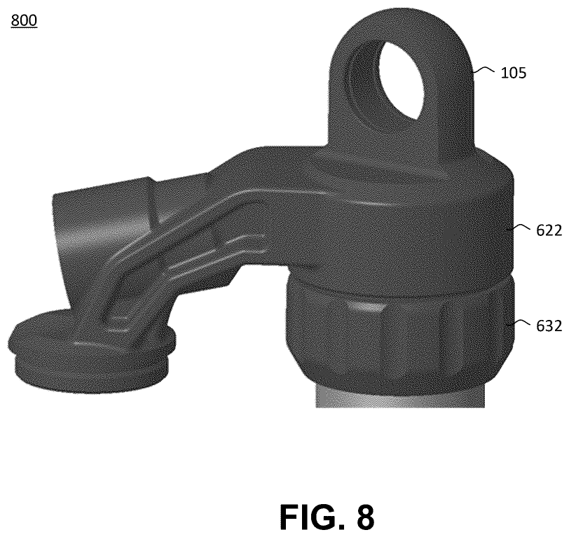

With reference now to FIG. 8, a perspective view of a bottom out zone adjustor shock body cap 622 for the shock assembly 800 with the position sensitive bottom out zone structure 200 is shown in accordance with an embodiment. In general, bottom out zone adjustor shock body cap 622 includes upper eyelet 105 and adjuster 632.

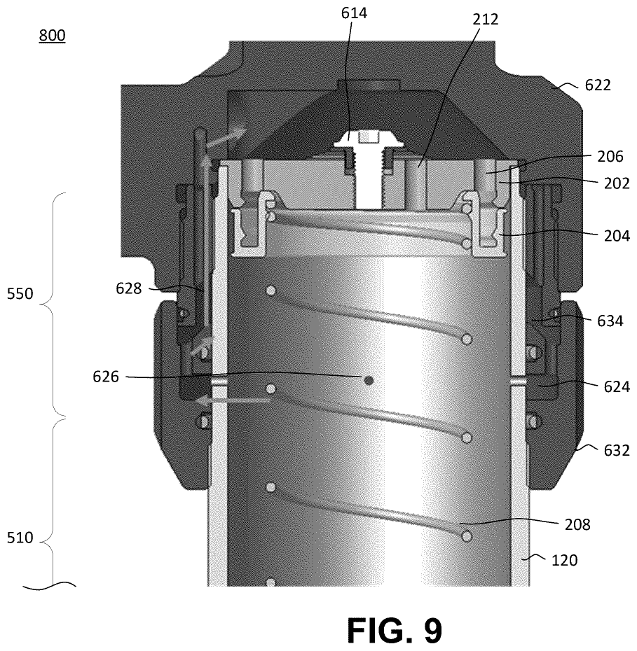

Referring now to FIG. 9, a cross-section view of the bottom out zone adjustor shock body cap 622 for the shock assembly 800 with the position sensitive bottom out zone structure 200 is shown in accordance with an embodiment. In one embodiment, body cap 622 includes bypass channels 624, bypass ports 626, adjuster 632, ledge 634, and valve 614.

Referring now to FIGS. 8 and 9, for purposes of clarity, the components and/or operation of shock assembly 800 that are similar to shock assembly 100 of FIG. 1 are not repeated but are incorporated herein by reference in their entirety. In addition, the components and/or operation of the position sensitive bottom out zone structure of shock assembly 800 that is similar to position sensitive bottom out zone structure 200 of FIG. 2 are not repeated but are incorporated herein by reference in their entirety.

For example, similar to the position sensitive bottom out zone structure 200, shock assembly 800 includes a position sensitive base valve 202 with one or more OD ports 206 and one or more ID ports 212. In one embodiment, the OD ports 206 are used to bypass the base valving (e.g., valve 614) used to control fluid flow through the one or more ID ports 212. First spring 208 is used to bias the check plate 204 away from the position sensitive base valve 202 when the damping piston is in the ride zone thereby keeping the OD ports 206 open such that the fluid flows unrestrictedly through OD ports 206 and the position sensitive base valve 202 does not significantly modify any damping characteristics of the shock assembly.

However, as check plate 204 approaches position sensitive base valve 202, check plate 204 will reduce and/or block the fluid flow through OD ports 206. Thereafter, any fluid flow through position sensitive base valve 202 will have to utilize ID ports 212 and thus exceed the cracking pressure of valve 614.

In one embodiment, bypass channels 624 provides a fluid bypass around position sensitive base valve 202. Fluid enters bypass channels 624 through bypass ports 626, and follows the path shown by fluid flow arrows 628 to reservoir 125. It should be noted that the number and placement of bypass ports 626 and their respective bypass channels 624 are not restricted to the number and placement shown. In one embodiment, there may be more or fewer bypass ports 626 and bypass channels 624 than shown.

In one embodiment, adjuster 632 is used to adjust the flow area of the bypass channels 624. In one embodiment, adjuster 632 is a rotating adjuster and the direction of rotation of adjuster 632 will increase or decrease the flow area of the bypass channels 624. In one embodiment, adjuster 632 is a slider that will slide up or down along damper housing 120 to increase or decrease the flow area of the bypass channels 624.

By providing a manual adjustability to the flow area of the bypass channels 624, the adjuster 632 can be used to adjust the compression firmness of the shock assembly 800 by adjusting the flow area available to the shock assembly during a compression stroke within the ride zone 510.

In one embodiment, the bypass ports 626 will be located within the ride zone portion such that there are no bypass ports 626 remaining on the compression side (or conversely the rebound side) when the piston enters the bottom out zone 550. For example, as the damping piston 218 moves into the bottom out zone 550, the bypass ports 626 will be covered or otherwise unavailable (e.g., below the piston) for the remainder of the compression stroke. As such, the bypass channels 624 will no longer be available and any further fluid flow will have to pass through the position sensitive base valve 202 via ID ports 212. As described herein, the blocking of the bypass channels 624 will cause an increase in the compression damping characteristics of shock assembly 800. This increase in compression damping characteristics of shock assembly 800 will significantly reduce or remove the opportunity for a deleterious bottom out impact.

In one embodiment, there may be one or more bypass ports 626 still remaining in the compression side (or conversely the rebound side) when the piston enters the bottom out zone 550. As such, a minimum of bypass channels 624 will still be operational while the check plate 204 is reducing the flow through the OD ports 206 of the position sensitive base valve 202. By having one or more bypass ports 626 still in use as the check plate 204 begins reducing the flow through the OD ports 206, an amount of pressure balancing (or cavitation reduction) is realized as their will not be a build up in pressure on one side of the position sensitive base valve 202 due to the closing of the OD ports 206.

In one embodiment, valve 614 is a pre-set blow-off valve that meter fluid flow through the ID ports 212 (similar to valve 214 discussed herein). In one embodiment, valve 614 is a shim valve. In another embodiment, valve 614 is a valve such as, but not limited to, a spool valve, a pressure relief valve, an electronic valve, a solenoid, and the like.

In one embodiment, valve 614 is set to a fixed cracking pressure. In one embodiment, valve 614 has a tunable cracking pressure. In one embodiment, valve 614 can be a manually tunable valve, an active valve, a semi active valve, a user controlled valve, an electronic valve, and the like (similar to valve 414 discussed herein). In one embodiment, instead of (or in addition to) reducing or restricting the flow through the ID ports 212, valve 614 will vary a flow rate through an inlet or outlet passage within the valve 614, itself. In other words, valve 614, can be used to meter the working fluid flow (e.g., control the rate of working fluid flow) with/or without adjusting the flow rate through the ID ports 212.

In one embodiment, the preload (or cracking pressure) of valve 614 can be manually adjusted via a screw or the like that is coupled with valve 614 and extends through body cap 622 such that it is accessible by a user while the shock assembly 100 is assembled. In one embodiment, upper eyelet 105 is offset to accommodate the addition of the manually adjustable feature.

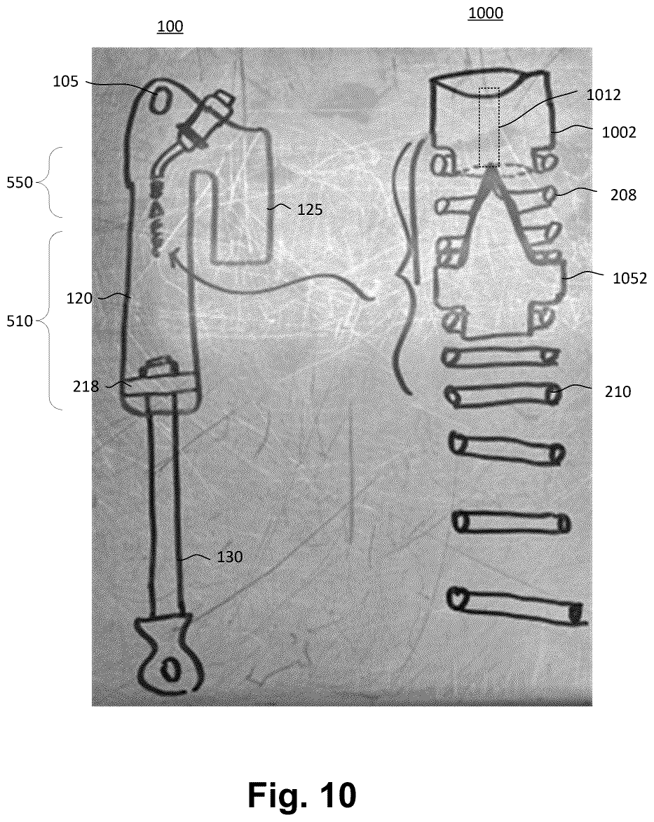

With reference now to FIG. 10, a cross section view of a needle and bleed port type position sensitive bottom out zone structure 1000 in a ride zone 510 of a shock assembly 100 is shown in accordance with an embodiment. In one embodiment, position sensitive bottom out zone structure 1000 included a position sensitive base valve 1002, a first spring 208, a second spring 210 and check plate 1052. In general, a number of the features of FIG. 10 are similar to that of FIGS. 2-4. As such, the description of the components of FIG. 10 that are similar to those described in FIGS. 2-4 are not repeated for purposes of clarity but are incorporated herein by reference in their entirety.

In one embodiment, check plate 1052 has at least one port (opening, or the like) that allows fluid to pass unencumbered therethrough. In one embodiment, check plate 1052 is a needle valve, spool valve, or the like that acts as a flow constricting feature.

In one embodiment, position sensitive base valve 1002 has at least one valve controlled fluid flow path and a central bypass flow path 1012 therethrough. In one embodiment, at least one valve (such as valve 214, 414, 614, or the like) is coupled with the at least one valve controlled fluid flow path of position sensitive base valve 1002 to manage fluid flow therethrough. In contrast, central bypass flow path 1012 is a bypass for the base valve.

During shock assembly operation in the ride zone 510, the damping characteristics will not be affected by the position sensitive base valve 1002 as the fluid will be able to flow unencumbered through the central bypass flow path 1012 and to the reservoir.

During a compression stroke and at the start of the shock assembly operation entering bottom out zone 550, the flow limiting feature of check plate 1052 will begin to reduce a fluid flow rate through the central bypass flow path 1012 of position sensitive base valve 1002. This flow restriction through the central bypass flow path 1012 will cause some fluid to begin utilizing the at least one valve controlled fluid flow path of the position sensitive base valve 1002. As such, position sensitive base valve 1002 will begin to control the rate of fluid passing therethrough and thus begin to modify the damping characteristics of the shock assembly. In one embodiment, there may be one or more bypass ports 626 still remaining in the compression side (or conversely the rebound side) when the piston enters the bottom out zone 550.

Once the shock assembly is operating in the bottom out zone 550, the flow limiting feature of check plate 1052 will be at its peak position with respect to the central bypass flow path 1012 of position sensitive base valve 1002 and be providing the maximum reducing and/or blocking of the fluid flow therethrough. This maximum flow restriction through the central bypass flow path 1012 will cause most or all of the fluid to have to utilize the at least one valve controlled fluid flow path of the position sensitive base valve 1002 to pass thereby. As such, position sensitive base valve 1002 will be in maximum control of the rate of any fluid passing therethrough and thus significantly modify the damping characteristics of the shock assembly.

In one embodiment, the spring constant of first spring 208 is altered to change the operation of position sensitive bottom out zone structure 1000 (i.e., gradual decrease in fluid flow through the central bypass flow path 1012 of position sensitive base valve 1002, suddenly blocking fluid flow through the central bypass flow path 1012 of position sensitive base valve 1002, etc.).

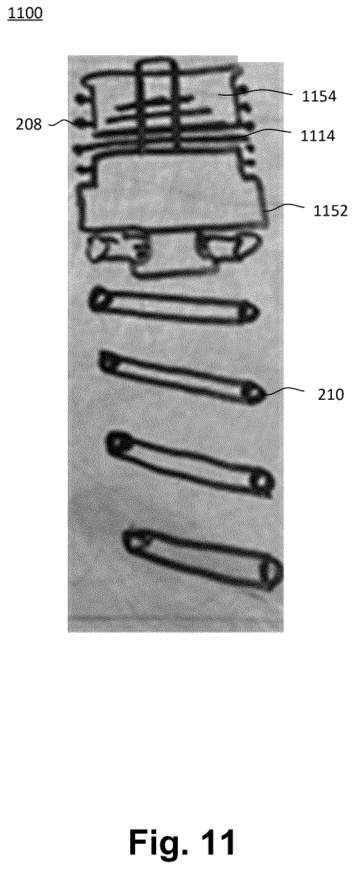

Referring now to FIG. 11, a cross section view of a position sensitive base valve 1154 of the position sensitive bottom out zone structure 1100 at the point of full entry into the bottom out zone 550 is shown in accordance with an embodiment. In general, a number of the features of FIG. 11 are similar to that of FIGS. 2-4. As such, the description of the components of FIG. 11 that are similar to those described in FIGS. 2-4 are not repeated for purposes of clarity but are incorporated herein by reference in their entirety.

In one embodiment, position sensitive base valve 1154 is fixed in its location within the shock assembly. In one embodiment, check plate 1152 includes a shim stack 1114 that meters fluid flow during a compression stroke. In one embodiment, while the shock assembly is in the ride zone 510 fluid can easily pass through shim stack 1114. However, when the shock assembly enters the bottom out zone 550 check plate 1152 (and shim stack 1114) will begin to be pressed against position sensitive base valve 1154. As the pressure on shim stack 1114 is increased as it is pressed against position sensitive base valve 1154, the cracking pressure of shim stack 1114 will also increase thereby modifying the compression damping characteristics of the shock assembly to a firmer setting.

As the shock assembly continues to move into the bottom out zone, the pressure exerted by check plate 1152 against position sensitive base valve 1154 will increase (which will increase the pressure on the shim stack 1114). As the pressure on the shim stack 1114 is increased, the cracking pressure of shim stack 1114 will also increase thereby further modifying the compression damping characteristics of shock assembly to an even firmer setting. As such, the increase in compression damping firmness of shock assembly will significantly reduce or remove the opportunity for a deleterious bottom out impact.

In one embodiment, the gradual increase in preload on shim stack 1114 allows for a more gradual change in compression damping firmness allowing for a more comfortable experience for the rider while removing bottom out opportunities.

In one embodiment, position sensitive base valve 1154 threads into body cap 622 (of FIG. 9). In one embodiment, different sized position sensitive base valves can be swapped out for different damping settings. In one embodiment, an external knob or dial can raise or lower the position of position sensitive base valve 1154 for tuning without swapping out the position sensitive base valve 1154.

During the rebound stroke, the pressure exerted by check plate 1152 against position sensitive base valve 1154 will be reduced to less than the spring force of first spring 208. In so doing, first spring 208 will separate check plate 1152 and position sensitive base valve 1154 such that there is no longer any additional preload pressure being applied to shim stack 1114 by position sensitive base valve 1154.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A position sensitive apparatus comprising:
a position sensitive base valve comprising a plurality of ports;
a check plate, configured to reduce a flow rate through at least one port of said plurality of ports of said position sensitive base valve based on a location of a damping piston; and
a first spring configured to bias said check plate away from said position sensitive base valve.

2. The position sensitive apparatus of claim 1, further comprising:
a first end of said first spring coupled with said damping piston; and
a second end of said first spring coupled with said check plate, such that a motion of said damping piston translates via said first spring to a motion of said check plate.

3. The position sensitive apparatus of claim 2, further comprising:
a spring retainer coupled with said damping piston, said spring retainer configured to fixedly couple said first spring with said damping piston.

4. The position sensitive apparatus of claim 1, further comprising:
a first end of said first spring coupled with said damping piston and located between said damping piston and said check plate; and
a second spring, wherein
a first end of said second spring is coupled with said position sensitive base valve; and
a second end of said second spring is coupled with said check plate, to connectively couple said check plate with said position sensitive base valve.

5. The position sensitive apparatus of claim 1, wherein said plurality of ports comprise:
at least one outer diameter port located a first radial distance from a center of said position sensitive base valve; and
at least one inner diameter port located a second radial distance from said center of said position sensitive base valve, where said first radial distance is larger than said second radial distance.

6. The position sensitive apparatus of claim 5, further comprising:
said check plate configured to reduce said flow rate through said at least one outer diameter port based on said location of said damping piston; and
a valve fluidly coupled with said at least one inner diameter port, said valve to meter a fluid flow rate therethrough.

7. The position sensitive apparatus of claim 5, further comprising:
said check plate configured to reduce said flow rate through said at least one inner diameter port based on said location of said damping piston; and
a valve fluidly coupled with said at least one outer diameter port, said valve to meter a fluid flow rate therethrough.

8. The position sensitive apparatus of claim 1, wherein said position sensitive base valve comprising said plurality of ports does not modify a compression damping characteristic of a shock assembly when said plurality of ports are open.

9. The position sensitive apparatus of claim 1, wherein said position sensitive base valve comprising said plurality of ports modifies a compression damping characteristic of a shock assembly when said check plate reduces said flow rate through said at least one port of said plurality of ports.

10. A position sensitive bottom out zone structure comprising:
an upper port through a wall of a main chamber to provide a first fluid pathway from said main chamber to a reservoir, said upper port located in a bottom out zone of said main chamber, said upper port comprising a first base valve with a firm compression setting;
a lower port through said wall of said main chamber to provide a second fluid pathway from said main chamber to said reservoir, said lower port located between said upper port and a damping piston, said lower port comprising a second base valve with a softer compression setting than said first base valve;
a check plate, configured to reduce a fluid flow rate through said lower port based on a location of said damping piston; and
a spring configured to bias said check plate away from said lower port.

11. The position sensitive bottom out zone structure of claim 10, further comprising:
a first end of said spring coupled with said damping piston; and
a second end of said spring coupled with said check plate, such that a motion of said damping piston translates via said spring to a motion of said check plate.

12. The position sensitive bottom out zone structure of claim 10, further comprising:
a spring retainer coupled with said damping piston, said spring retainer configured to fixedly couple said spring with said damping piston.

13. The position sensitive bottom out zone structure of claim 10, wherein said check plate comprises:
at least one port therethrough; and
an outer diameter (OD) portion configured to provide a fluid seal between said main chamber and said check plate, said OD portion sized to cover said lower port when said damping piston is in said bottom out zone.

14. The position sensitive bottom out zone structure of claim 10, wherein said first base valve and said second base valve are selected from a group consisting of: a non-adjustable valve, a tunable valve, a variable pressure valve, a spool valve, a shim valve, a pressure relief valve, an electronic valve, and a solenoid.

15. A shock assembly comprising:
a damper chamber comprising at least one bypass port through a ride zone portion thereof;
a piston coupled to a piston shaft and configured for operation within said damper chamber, said piston configured to divide said damper chamber into a compression side and a rebound side, wherein said piston will restrict fluid flow through said at least one bypass port when said piston enters a bottom out zone portion of said damper chamber;
a base valve at a compression end of said damper chamber, said base valve comprising a plurality of ports;
a check plate configured to restrict fluid flow through at least one of said plurality of ports of said base valve based on a location of a damping piston;
a first spring coupling said check plate with said base valve, said first spring biases said check plate away from said base valve;
a second spring coupling said check plate with said damping piston, said second spring biases said check plate away from said damping piston; and
a body cap comprising:
a bypass channel fluidly coupling said at least one bypass port with a fluid reservoir; and
an adjuster configured to adjust a flow area of said bypass channel.

16. The shock assembly of claim 15, wherein said adjuster is manually rotatable with respect to said body cap to adjust said flow area of said bypass channel.

17. The shock assembly of claim 15, wherein said adjuster is manually slidable with respect to said body cap to adjust said flow area of said bypass channel.

18. The shock assembly of claim 15, wherein said adjustment of said flow area of said bypass channel changes a compression firmness of said shock assembly.

19. The shock assembly of claim 15, wherein said plurality of ports comprise:
at least one outer diameter port located a first radial distance from a center of said base valve; and
at least one inner diameter port located a second radial distance from said center of said base valve, where said first radial distance is larger than said second radial distance.

20. The shock assembly of claim 19, further comprising:
said check plate configured to restrict a flow rate through said at least one outer diameter port based on said location of said piston; and
a valve fluidly coupled with said at least one inner diameter port, said valve to meter a fluid flow rate therethrough.

21. The shock assembly of claim 19, further comprising:
said check plate configured to restrict a flow rate through said at least one inner diameter port based on said location of said piston; and
a valve fluidly coupled with said at least one outer diameter port, said valve to meter a fluid flow rate therethrough.

22. A position sensitive apparatus comprising:
a position sensitive base valve comprising:
at least one valve controlled fluid flow path configured to manage fluid flow therethrough; and
a central bypass flow path configured to provide a bypass of said at least one valve controlled fluid flow path, wherein said fluid flow through said central bypass flow path is unencumbered by said position sensitive base valve;
a flow limiting check plate, configured to reduce a flow rate through said central bypass flow path based on a location of a damping piston; and
a first spring coupling said flow limiting check plate with said position sensitive base valve, said first spring biases said flow limiting feature of said flow limiting check plate away from said central bypass flow path of said position sensitive base valve.

23. A position sensitive apparatus comprising:
a position sensitive base valve comprising at least one base port;
a check plate comprising a least one check plate port;
a shim stack coupled with said check plate and located between said check plate and said position sensitive base valve, said shim stack configured to reduce a flow rate through said at least one base port of said position sensitive base valve based on a location of a damping piston; and
a first spring coupling said check plate with said position sensitive base valve, said first spring biases said check plate away from said position sensitive base valve.
